(19) United States
(12) Patent Application Publication
(10) Pub. No.: US 2020/0131794 A1
(43) Pub. Date: Apr. 30, 2020

(54) Integrated Structure Protection Systems

(71) Applicant: Gil Panzer, Boca Raton, FL (US)

(72) Inventor: Gil Panzer, Boca Raton, FL (US)

(21) Appl. No.: 16/436,970

(22) Filed: Jun. 11, 2019

Related U.S. Application Data
(60) Provisional application No. 62/751,578, filed on Oct. 27, 2018.

(51) Int. Cl. E04H 9/14; E05B 65/00; E04B 1/98

(52) U.S. Cl. CPC E04H 9/14; E04B 1/98; E05B 65/006

(57) ABSTRACT

An integrated structure protection system is provided. The system includes a subterranean anchor assembly. The subterranean anchor assembly includes an anchoring mechanism. The anchoring mechanism configured to secure the subterranean anchor assembly to below grade media. The anchoring mechanism also includes an attachment mechanism. The system also includes a cover positionable on top of and configured to provide protection to the subterranean anchor assembly when the system is in stored mode. Further, the system includes a strapping device configured to connect an end of the device to the attachment mechanism. Additionally, the integrated system also includes a structure attachment system configured to connect an other end of the strapping device to a structure. Further still, the system also includes a structure protection system tensioning apparatus configured to provide tension in the strapping device when the strapping device is connected to the structure and the subterranean anchor assembly.

### CROSS-REFERENCE TO RELATED APPLICATIONS

This application claims priority to provisional application 62/751,578 filed on Oct. 27, 2018, and is incorporated herein by reference in its entirety.

### FIELD OF THE INVENTION

The present invention relates generally to structure protection systems, and more particularly, to integrated structure protection systems, which utilize subterranean anchor and connection points to provide augmented structure protection.

### BACKGROUND OF THE INVENTION

Many methods and systems have been used unsuccessfully attempting to provide additional structural support to existing structures. Several devices and methods have been created to rectify the problem of providing additional structural support to pre-existing structures. These devices, systems and methods have not been reliable or effective.

Throughout the world, the problem of providing additional structural support to pre-existing structures, to protect the structure from damage, has posed a problem. Quite often buildings and other structures have been constructed without the appropriate integral strength to withstand environmental conditions.

Throughout different regions of the world, structures are exposed to environmental conditions such as, but not limited to, hurricanes, tornadoes, typhoons, earthquakes, microbursts, tropical storms, and high winds. Many structures are constructed without the appropriate structural integrity required to withstand these environmental conditions. When such structures are exposed to these environmental conditions, the structures fail, causing physical damage to the structure and endangering human and other living beings. The current state of the art does not provide for efficiently or effectively compensating for the lack of structural integrity in pre-existing structures. For example, when hurricanes or other natural forces manifest themselves in communities, damage occurs to structures in orders of magnitude far beyond imaginable to engineers and planners who were charged in constructing the structures.

In many regions of the world, structures require effective, efficient, and rapid structural augmentation to withstand an upcoming environmental event. To date, there have been no solutions to deploying systems to augment the structural integrity of buildings and other structures in response to an upcoming environmental event, in an effective, efficient, or time sensitive manner.

As climate change continues to affect planet Earth and continues to create environmental conditions which increase in strength, intensity, and frequency, most structures exposed to these conditions are not designed to withstand the physical forces caused by these environmental conditions. Currently damage to the aggregate structures within a community result in financial ruin to families, communities, counties, and states. Further, these damages disrupt the communities, disrupt commerce, and require considerable amount of emergency responders to react to the damage caused by these environmental conditions.

Further, in many regions of the world building codes are enacted to ensure proper structural integrity is designed into the structure prior to construction. Unfortunately, the physical forces that are manifested by the environmental conditions, far exceed those forces that were envisioned by the engineers and planners who authored the building codes. Therefore, most buildings, even if built in accordance with the appropriate building codes, suffer significant structural damage when exposed to severe environmental conditions.

Most regions in the world utilize insurance entities to help mitigate the costs of catastrophic damage caused by environmental conditions. Most of these insurance entities are subsidized by their respective local, state, or federal governments. Because the magnitude of damage to regions affected by severe environmental conditions is quite often more than anticipated, the insurance entities are offered relief by the local, state, or federal governments. These severe environmental conditions affect all citizens because the cost of these environmental conditions is paid by all the tax payers.

Many residential communities operate with a home owners association. Most of these associations do not allow physical modifications to the residences. Because of these restrictions, structural integrity augmentation is quite often hindered by these associations.

Accordingly, there is an established need for a structure protection system which solves at least one of the aforementioned problems. Further, there is an established need for an integrated structure protection system which can augment structural integrity, deploy structural augmentation in an efficient, effective, and time sensitive fashion, reduce operating costs, is reusable, reduces waste, provides sufficient augmented structural support in a compressive or tensile fashion, can be used in conjunction with other structural augmentation systems, or may be used as a stand-alone structural augmentation system.

### SUMMARY OF THE INVENTION

According to an aspect of the present invention, an integrated structure protection system is provided. The integrated structure protection system includes a subterranean anchor assembly. The subterranean anchor assembly includes an anchoring mechanism. The anchoring mechanism is configured to secure the subterranean anchor assembly to below grade media. The anchoring mechanism also includes an attachment mechanism configured for connecting the strapping device to the subterranean anchor assembly. The integrated structure protection system also includes a cover positionable on top of and configured to provide protection to the subterranean anchor assembly when the integrated structure protection system is in stored mode. Further, the system also includes a strapping device. The device is configured to connect an end of the device to the attachment mechanism of the subterranean anchor assembly. Additionally, the integrated structure protection system includes a structure attachment system configured to connect another end of the strapping mechanism to a structure. Further still, the integrated structure protection system also includes a structure protection system tensioning apparatus configured to provide tension in the strapping device when the strapping device is connected to the structure and the subterranean anchor assembly, wherein the tensioning apparatus provides additional structural support to the structure when the integrated structure protection system is in deployed mode.

According to another aspect of the present invention, an integrated structure protection apparatus is provided. The integrated structure protection apparatus includes a subterranean anchor assembly. The subterranean anchor assembly includes an anchoring mechanism. The anchoring mechanism is configured to secure the subterranean anchor assembly to below grade media. The anchoring mechanism also includes an attachment mechanism. The integrated structure protection apparatus also includes a cover positionable on top of and is configured to provide protection to the subterranean anchor assembly when the integrated structure protection apparatus is in stored mode. Further, the apparatus includes a strapping device. The device is configured to connect an end of the strapping device to the subterranean anchor assembly. Additionally, the integrated structure protection apparatus includes a structure attachment system configured to connect another end of the strapping mechanism to a structure. Further still, the integrated structure protection apparatus also includes a structure protection apparatus tensioning apparatus configured to provide tension in the strapping device when the strapping device is connected to the structure and the subterranean anchor assembly, wherein the tensioning apparatus provides additional structural support to the structure when the integrated structure protection apparatus is in deployed mode.

The present invention is directed to a convenient, effective, efficient and labor-saving integrated structure protection system, which can be used to protect commercial and residential structures. These systems are used to minimize structural damage, reduce financial costs to families and communities, mitigate disruption to communities, and help to prevent loss of human and other living beings. Further, these systems are scalable.

In a first implementation of the invention, an integrated structure protection system comprises a subterranean anchor. The integrated structure protection system also includes connection points on the anchor. The connection points are configured to connect with other elements to provide augmented structural support in a compressive or tensile fashion.

In another aspect, the integrated structure protection system can include a shock absorber within the anchor.

In yet another aspect, the integrated structure protection system container can further be placed in various angles relative to the structure, such as, but not limited to, 90, 80, 70, 60, 50, 45, 30, 20, 10, 5, and/or 0 degrees, and/or any other angle in between designed to provide protection to the structure.

In another aspect, the integrated structure protection system container can further include materials configuring the integrated structure protection system to provide appropriate minimal displacement and movement of the structure while still maintaining structural augmentation integrity.

In yet another aspect, the integrated structure protection system container can help withstand the forces of hurricane winds.

In another aspect, the integrated structure protection system can further resist horizontal movement caused by an earthquake.

In yet another aspect, the integrated structure protection system can also include anchors including poured concrete posts.

In another aspect, integrated structure protection system can include a ball of concrete at the bottom of the anchor.

In yet another aspect, the integrated structure protection system can also include stainless steel anchors.

In another aspect, the integrated structure protection system can include removable covers on top of the anchors, providing for protection of the anchors and aesthetic appeal for the area surrounding a structure.

In yet another aspect, the integrated structure protection system can also include covers on top of the anchors which can also function as part of the integrated structure protection system.

In another aspect, the integrated structure protection system can include straps, the straps configured to connect a plurality of anchors to provide augmented structural protection.

In yet another aspect the integrated structure protection system, can also include mechanical connections to a plurality of anchors providing for compressive and/or tensile resistance against forces on the structure.

In another aspect of the integrated structure protection system, the system provides for mitigation of lateral movement of structures with damping devices.

In yet another aspect of the present invention, the system provides for tensile resistance for the structure.

In another aspect of the invention, the anchors can include augers, the augers providing for additional adhesion for the anchors with the surrounding media and/or earth holding the anchors in place.

In yet another aspect of the invention, the anchor, being subterranean, can also be covered by dirt and/or sod and/or plastic cover and/or tile and/or concrete cover sized and configured to aesthetically blend in with a surrounding surface of the anchor.

In another aspect of the invention the cover may be configured to be locked and/or secured in place to minimize unauthorized access to the anchor.

In yet another aspect of the invention, the anchors can also include a poured concrete beam, wherein stainless-steel anchors and a PVC pipe, the PVC pipe including diameters configured to house anchors with a plurality of sizes and/or diameters. The PVC pipe may be configured to be inserted in wet concrete during an installation process.

In another aspect of the invention, the stainless-steel anchors can be configured to provide an attachment location for straps and/or rods and/or web material and/or cables and/or shock absorbers and/or dashpots and/or vibration isolation devices and/or rubber snubbers and/or ropes and/or other elements for providing compressive and/or tensile resistance to stresses to an existing structure.

In yet another aspect of the invention, the PVC pipe can also be configured to be partially inserted in the wet concrete with the stainless-steel anchor located in a middle of the pipe during an installation process.

In another aspect of the invention, a top of the PVC pipe is below grade.

In yet another aspect of the invention, a top of the cover over the anchor can also be configured to be flush with the surrounding ground area, wherein the cover is positionable to provide for pedestrian and/or vehicular traffic to transit on top of the cover, the pedestrian and/or vehicular traffic takes place without any impediment and/or the anchor and/or cover over the anchor is unnoticeable to an objective observer and/or is not visible to plain sight.

In another aspect of the invention, the anchor can also be secured to surrounding subterranean media with an auger, the auger including concrete and/or excluding concrete.

In yet another aspect of the invention, the top of the cover can also be configured to be driven and/or walked on top of.

In another aspect of the invention, the anchor and/or cover can be configured to be included within an existing structure. The anchor and/or cover may be included in a wall and/or roof and/or load bearing element of a structure. The anchor and/or cover may be configured to provide augmented vertical and/or horizontal structural support.

In yet another aspect of the invention, cables and/or web material and/or straps and/or rigid support elements and/or other structural elements may also be stored under the cover of the anchor, wherein the cables and/or web material and/or straps and/or rigid support elements and/or other structural elements may be deployed upon opening the cover.

In another aspect of the invention, cables and/or web material and/or straps and/or rigid support elements and/or other structural elements may be detachable and/or secured to anchors and/or other structural support elements of an existing structure.

In yet another aspect of the invention, the integrated structure protection system can also include tensioning and/or compressing elements, such as, but not limited to, tensioning unions, hydraulic jack units, power puller, winch, pulleys, and/or ratcheting tool.

In another aspect of the invention, the integrated structure protection system can include connection elements on top of an existing structure and/or cables and/or web material and/or straps and/or rigid support elements and/or other structural elements affixed on joists and/or rafters and/or beams and/or load bearing walls and/or soffits of an existing structure.

In yet another aspect of the present invention, the integrated structure protection system can be configured to be deployed and in place to provide augmented structural support to an existing structure automatically and/or manually.

In another aspect of the present invention, the integrated structure protection system can be configured to be deployed, automatically and/or manually, and in place to provide augmented structural support to an existing structure, within an elapsed time frame from time of warning of an event to the occurrence of the event. For example, but not limited to, hurricane warning, tornado warning, tsunami warning, cyclone warning, earthquake warning, micro burst warning, typhoon warning, and/or an environmental event which will expose existing structures to excessive stresses.

In yet another aspect of the invention, the integrated structure protection system, can also include pneumatic and/or hydraulic driven actuators. The actuators configured to deploy the integrated structure protection system automatically upon activation of a warning signal, wherein the warning signal is prompted by an anticipated event.

In another aspect of the invention, the integrated structure protection system can include external and/or internal attachment connections within and/or on an outside of the existing structure, which the system is protecting.

In yet another aspect of the invention, the integrated structure protection system can include shock absorbers and/or dashpots in the cables and/or web material and/or straps and/or rigid support elements and/or other structural elements.

In another aspect of the invention, the integrated structure protection system can be configured to provide protection to, but not limited to, garage doors, window, door, and/or other elements of an existing structure which require additional structural support.

In yet another aspect of the invention, the system can also include pressure distribution plates, the plates interfacing with structural elements of the existing structure and configured to distribute forces over a cross section of the plates.

In another aspect of the invention, the system can include connections to structural elements in an attic of an existing structure, the connections including openings to the structural elements in the attic. The openings configured to deploy the system within the existing structure, wherein the system is configured to provide structural protection within the existing structure.

In yet another aspect of the invention, the system can also include anchors within the existing structure.

In another aspect of the invention, the system is configured to prevent tripping hazards, wherein the system, when not deployed, is contained underground and/or within existing structures.

In yet another aspect of the invention, the system can also be configured to be protected from the elements, wherein the system includes an environmentally sealed cover over anchors and/or connection points and/or covers.

In another aspect of the invention, the system can include a plurality of anchors and/or a plurality of covers and/or a plurality of shock absorbers and/or dashpots and/or a plurality of pneumatic and/or hydraulic driven actuators and/or a plurality of cables and/or web material and/or straps and/or rigid support elements and/or other structural elements, configured to provide adequate protection for existing structures of various sizes.

In yet another aspect of the invention, the system is configured to allow minimal movement of the structural elements of the system, and to provide protection of the existing structure by not yielding to the external forces being felt by the existing structure.

In another aspect of the invention, the system includes an anchor and cover, wherein the anchor and cover are hidden below grade and are covered with dirt and/or sod. The system can further be configured to provide mowing the sod above the hidden anchor and cover. The system can be also configured to prevent tripping hazards.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a top view of an integrated structure protection system in deployed mode, in accordance with an embodiment of the present invention;

FIG. 2 presents a side view of the integrated structure protection system in deployed mode; and

FIG. 3 presents a cross sectional view of a subterranean anchor assembly in an embodiment of the present invention.

Like reference numerals refer to like parts throughout the several views of the drawings.

### DETAILED DESCRIPTION

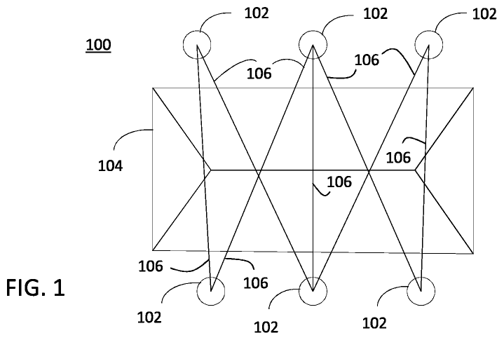

The following detailed description is exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, embodiments of the present invention are directed towards methods and systems of integrated structure protection systems wherein the system is configured to be hidden while not deployed and to be able to deploy the system automatically and/or manually within the time afforded after a warning is issued.

FIG. 1 presents a top view of an embodiment of an integrated structure protection system 100 when in deployed mode. The system 100 can include a plurality of subterranean anchor assemblies 102. The subterranean anchor assemblies 102 can be positionable around a perimeter of a structure 104. The subterranean anchor assemblies 102 can connect to a strapping device 106, and as shown, the strapping devices 106 can be connected to two or more subterranean anchor assemblies 102. The strapping devices 106 can be configured to be positionable on top of the structure 104 to provide protection to a roof of the structure.

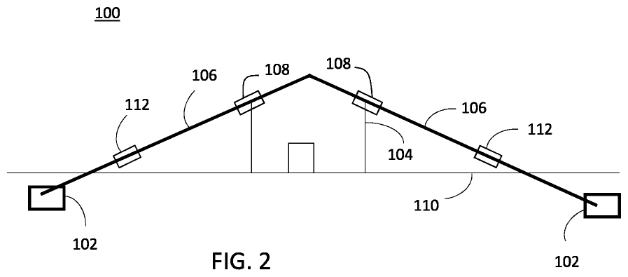

Turning to FIG. 2, a side view of an embodiment of an integrated structure protection system 100 is illustrated. The system 100 can include subterranean anchor assemblies 102. The anchor assemblies 102 can be connected to an end of the strapping device 106 and another end of the strapping device 106 can be connected to a structure attachment system 108. The structure attachment system 108 configured to connect the strapping device 106 to the structure 104. As shown, the subterranean anchor assemblies 102 can be positionable below ground level 110. The subterranean anchor assemblies 102 configured to be located below grade provides that the assemblies 102 are hidden from plain sight when the system 100 is in stored mode. Further, because the assemblies 102 are below ground level 110, the system 100 does not interfere with above ground pedestrian or vehicular traffic when the system 100 is in stored mode. And as displayed, the system 100 can include a structure protection system tensioning apparatus 112, the apparatus 112 configured to provide tension in the strapping device 106 when the device 106 is connected to the structure 104, by the structure attachment system 108, and to the subterranean anchor assembly 102, wherein the tensioning apparatus 112 provides additional structural support to the structure 104 when the system 100 is in deployed mode.

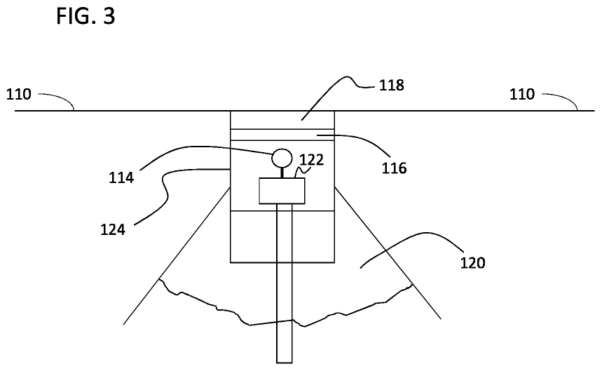

As best seen in FIG. 3, a side view of the subterranean anchor assembly 102 in stored mode is displayed. As shown, the assembly 102 can be positionable below ground level 110 configured to be hidden from plain sight when the system 100 is in stored mode. The assembly 102 can include an attachment mechanism 114 configured for connecting the strapping device 106, not shown, to the assembly 102 when the system 100 is in deployed mode. The system 100 can include a cover 116, the cover 116 positionable on top of and configured to provide protection to the assembly 102 when the system 100 is in stored mode. The cover 116 can be configured to include locking mechanisms, not shown, in order to prevent unauthorized access to the assembly 102. In some embodiments, a top of the cover 116 can be flush with the ground level 110. In some embodiments the cover can include but not limited to tile, concrete, plastic, stainless steel, ceramics, and/or fiberglass. On top of the cover 116 material 118 can be placed over the cover 116 arranged to render the subterranean anchor assembly 102 not visible to plain sight. Further, the material 118 can include but not limited to dirt, earth, sod, tile, concrete, plastic, stainless steel, ceramics, and/or fiberglass. The material can be chosen to coordinate with the surrounding surface area at ground level 110. The material 118 further acts to comply with local ordinances, zoning laws, and local home owner association rules. The assembly 102 can also include an anchoring mechanism 120 configured to secure the assembly 102 to below grade media 122. In some embodiments, the assembly can also include a shock absorber or dashpot 124 configured to act as a damper to impact forces. In some embodiments the dashpot 122 can include hydraulic cylinders. In embodiments the assembly 102 can include a housing 124.

In an exemplary embodiment of the present invention, an integrated structure protection system can include a system to provide protection from hurricanes. These systems include hidden anchors and hidden structural augmentation elements that can be deployed within the time frame afforded by a warning of an imminent hurricane. In some exemplary embodiments, the system may be put in place providing for full protection from category 5 hurricanes. In some embodiments, the system can be configured to provide greater protection if deemed necessary.

In an embodiment of the present invention the system can include rigid structural augmentation elements to protect structures from an earthquake. The system can be configured to help protect structures from an earthquake.

In an embodiment of the present invention, the systems anchors are hidden below grade, preventing trip hazards and allowing pedestrian traffic and vehicular traffic to occur without impediment and without noticing that anchors and associate elements are hidden below grade. The hidden anchors are then covered with a cover to allow them to be hidden from plain sight.

In an embodiment of the present invention, the system elements are all hidden from plain sight allowing owners of structures to install the system without violating a city ordinance and/or zoning ordinance and/or home owner association covenants.

In an embodiment of the invention, the system is deployed by connecting straps from a plurality of anchor attachment points to other anchor attachment points with the straps going over the top of the roof of a structure and connecting to another anchor attachment point. The straps are then tensioned to provide additional support.

In an embodiment of the invention, the system is deployed by connecting rigid structural elements to the attachment points of the anchors and attaching the rigid structural elements to the structure.

In another embodiment of the invention, the system can be configured to mitigate damage to a structure with combination of embodiments of the present invention.

In an embodiment of the invention, the system includes a plurality of straps. The system also includes a plurality of subterranean anchor devices. The anchor devices include a plurality of fastening devices for attaching the straps to the anchor device. The anchor devices are secured to the surround underground media with, but not limited to, concrete and/or augers and/or pilings and/or underground footers. The fastening devices can include a plurality of mechanisms designed for quick connect and disconnect. An end of the strap can be attached to the anchor device. Another end of the strap can be secured to a position on the structure and/or can be secured to another anchor device. The straps are then tensioned to provide the additional structural support for the structure. The straps can be attached to the anchor devices and the straps can then be placed on and/or within and/or about a structure. The straps can be wrapped around the structure to provide additional support. Further, an end of rods and/or beams can be attached to the anchor devices and another end of the rods and/or beams can be attached to structure to provide augmented structural support. The system can also include pressure distribution plates interposed between the rods and/or beams and the structure to provide for a distribution of stress on a cross section of the structure.

The system components can be stored underground and/or within the structure and/or within a storage area. The underground components of the system can be covered with a cover. The cover can include a securing mechanism to ensure only authorized access to the underground components of the system. The cover can also be covered with dirt and/or sod.

The anchor devices can include additional elements to provide structural support to a structure. The additional elements can include shock absorbers and/or tensioning devices and/or additional structural support elements such as, but not limited to, rods, beams, cables, nets, webs, roped, winches, ratcheting devices and/or pulleys. The additional elements can be stored underground and/or within the structure and/or in a separate storage area. The straps are positionable on and/or within and/or about the structure to provide augmented structural support in tensile and/or compressive reactive and active force. The augmented structural support prevents structure damage from external or internal forces caused by, but not limited to hurricanes, tornadoes, earthquakes, high winds, microbursts, nor′easters, and other environmental events which can damage structures, if not for the deployment of an embodiment of an integrated structure protection system.

While the foregoing written description of the exemplary embodiments enables one of ordinary skill to make and use what is considered presently to be the best mode thereof, those of ordinary skill will understand and appreciate the existence of variations, combinations, and equivalents of the specific embodiment, method, and examples herein. The exemplary embodiments should therefore not be limited by the above described embodiment, method and examples, but all embodiments and methods within the scope and spirit of the exemplary embodiments as claimed.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

Insofar as the description above and the accompanying drawings disclose any additional subject matter that is not within the scope of the claims below, the inventions are not dedicated to the public and the right to file one or more applications to claim such additional inventions is reserved.

What is claimed is:

1. An integrated structure protection system, comprising:
a subterranean anchor assembly, the assembly further comprising:
an anchoring mechanism, the mechanism configured to secure the subterranean anchor assembly to below grade media; and
an attachment mechanism;
a cover positionable on top of and configured to provide protection to the subterranean anchor assembly when the integrated structure protection system is in stored mode;
a strapping device, the device configured to connect an end of the device to the attachment mechanism of the subterranean anchor assembly;
a structure attachment system configured to connect an other end of the strapping device to a structure;
a structure protection system tensioning apparatus configured to provide tension in the strapping device when the strapping device is connected to the structure and the subterranean anchor assembly, wherein the tensioning apparatus provides additional structural support to the structure when the integrated structure protection system is in deployed mode.

2. An integrated structure protection system of claim 1, wherein the tension apparatus further comprises automatic tensioning devices.

3. An integrated structure protection system of claim 1 further comprising shock absorbers.

4. An integrated structure protection system of claim 1 wherein the cover includes a locking mechanism, the locking mechanism configured to secure the subterranean anchor assembly when in stored mode and prevent unauthorized access to the subterranean anchor assembly.

5. An integrated structure protection system of claim 1, wherein the subterranean anchor assembly further includes stainless steel anchors.

6. An integrated structure protection system of claim 1, further comprising an automatic deployment actuation device configured to deploy the integrated structure protection system from stored mode to deployed mode automatically upon receiving an actuation signal.

7. An integrated structure protection system of claim 1, further comprising rigid support elements configured to attach to the structure and to the subterranean anchor assembly.

8. An integrated structure protection system of claim 1, wherein the subterranean anchor assembly houses and provides protection for the integrated structure protection system.

9. An integrated structure protection system of claim 1, wherein the strapping device includes a plurality of straps, nets, cables, rods, ratcheting devices, ropes, and/or pulleys.

10. An integrated structure protection system of claim 1, further comprising:
rigid structural elements; and
a plurality of pressure distribution plates, the plates interposed between the rigid structural elements and the structure configured to provide for a distribution of stress on a cross section of the structure.

11. An integrated structure protection apparatus, comprising:
a subterranean anchor assembly, the assembly further comprising:
an anchoring mechanism, the mechanism configured to secure the subterranean anchor assembly to below grade media; and
an attachment mechanism;
a cover positionable on top of and configured to provide protection to the subterranean anchor assembly when the integrated structure protection apparatus is in stored mode;
a strapping device configured to connect an end of the strapping device to the subterranean anchor assembly
a structure attachment system configured to connect an other end of the strapping device to a structure; and
a structure protection apparatus tensioning apparatus configured to provide tension in the strapping device when the strapping device is connected to the structure and the subterranean anchor assembly, wherein the tensioning apparatus provides additional structural support to the structure when the integrated structure protection apparatus is in deployed mode.

12. An integrated structure protection apparatus of claim 11, wherein the tension apparatus further comprises automatic tensioning devices.

13. An integrated structure protection apparatus of claim 11 further comprising shock absorbers.

14. An integrated structure protection apparatus of claim 11 wherein the cover includes a locking mechanism, the locking mechanism configured to secure the subterranean anchor assembly when in stored mode and prevent unauthorized access to the subterranean anchor assembly.

15. An integrated structure protection apparatus of claim 11, wherein the subterranean anchor assembly further includes stainless steel anchors.

16. An integrated structure protection apparatus of claim 11, further comprising an automatic deployment actuation device configured to deploy the integrated structure protection apparatus from stored mode to deployed mode automatically upon receiving an actuation signal.

17. An integrated structure protection apparatus of claim 11, further comprising rigid support elements configured to attach to the structure and to the subterranean anchor assembly.

18. An integrated structure protection apparatus of claim 11, wherein the subterranean anchor assembly houses and provides protection for the integrated structure protection apparatus.

19. An integrated structure protection apparatus of claim 11, wherein the strapping device includes a plurality of straps, nets, cables, rods, ratcheting devices, ropes, and/or pulleys.

20. An integrated structure protection apparatus of claim 11, further comprising:
rigid structural elements; and
a plurality of pressure distribution plates, the plates interposed between the rigid structural elements and the structure configured to provide for a distribution of stress on a cross section of the structure.
